(19) United States
(12) Patent Application Publication
(10) Pub. No.: US 2025/0067247 A1
(43) Pub. Date: Feb. 27, 2025

(54) AUXILIARY POWER SUPPLY

(71) Applicant: Siemens Gamesa Renewable Energy A/S, Brande (DK)

(72) Inventors: Samuel Hawkins, Vejle (DK); Rene Salkvist Nielsen, Sunds (DK)

(21) Appl. No.: 18/729,036

(22) PCT Filed: Dec. 29, 2022
(86) PCT No.: PCT/EP2022/088020

§ 371 Date: Jul. 15, 2024

(30) Foreign Application Priority Data
Jan. 28, 2022 (EP) 22153883.8

(51) Int. Cl. F03D 9/11; F03D 9/25; F03D 80/80

(52) U.S. Cl. CPC F03D 9/11; F03D 9/25; F03D 80/821; F05B 2220/706

(57) ABSTRACT

An auxiliary power supply arrangement of a wind turbine is provided, including a standby power supply configured to cover the average power requirements of auxiliary devices of the wind turbine; and an energy storage unit, which energy storage unit is configured to cover transient power requirements of the auxiliary devices and/or to supplement the standby power supply in covering the transient power requirements of the auxiliary devices. Also provided is a wind turbine including such an auxiliary power supply arrangement adapted to supply power to auxiliary devices of the wind turbine during an off-grid state of the wind turbine; and a method of operating such a wind turbine.

### BACKGROUND

A wind turbine generally comprises various auxiliary components that require power in order to operate. For example, the yaw system of a horizontal-axis wind turbine might comprise several yaw drive units, each with a pinion that engages with the yaw ring, and a motor to turn the pinion. Similarly, motors of a pitch system are deployed to pitch about their longitudinal axes. Another example of an auxiliary device might be a cooling arrangement that comprises various motor-driven pumps to circulate a cooling fluid, a dehumidifier, a lubrication system, etc. Temporary auxiliaries can be various machines or tools required during service routines, pre-commissioning, commissioning, testing procedures etc. Generally, such auxiliaries can draw high currents of varying magnitudes, depending on the effort being expended.

In addition to the auxiliary devices realised as permanent fixtures of a wind turbine, it may be necessary to provide power for tools and equipment during installation, commissioning, maintenance, repair etc. at various stages in the lifetime of the wind turbine. To this end, a wind turbine may be provided with a system including electrical outlets or sockets for electrical tools and equipment. These power outlets or sockets may also be needed when the wind turbine is off-grid. The tools and equipment used during installation, commissioning, and maintenance stages can be the greatest power consumers.

The motor of an auxiliary device may draw high inrush currents, depending on the magnetization of the motor's windings. A high inrush current is associated with a high-amplitude burst of power for a brief duration, i.e. with low total energy.

During normal operation of the wind turbine, i.e. when the wind turbine is connected to the grid, any such auxiliary can be powered by the wind turbine generator, or from the grid.

During an off-grid situation, a wind turbine may avail of a standby power supply, for example the accessory power component proposed in US2012056425A1. A standby power supply may be a permanent fixture of a wind turbine or may be transported to an off-grid wind turbine. The standby power supply must be specified to the highest peak current that will be drawn by an auxiliary device, and not to the “steady state” power consumption during normal operation of that auxiliary device. Power consumption peaks may be relatively rare, arising only infrequently for example when a motor-driven device is switched on, but the capacity of a standby power supply must be large enough to cope with the largest possible current peak to avoid overloading and tripping, which would result in the power supply shutting down and leaving the wind turbine without any power at all. This situation must be avoided since it is important to be able to continue basic functions such as yawing into the wind, keeping the nacelle interior temperature above freezing, maintaining a dry interior, etc. As a result, a standby power supply for an off-grid wind turbine generally has a large capacity, for example in the order of 150 kVA. A diesel generator with a rating of this order may weigh several tons and consumes large amounts of diesel fuel, creating challenges in both refuelling logistics and operational costs. The costs of rental, transportation and frequent refuelling of a large and heavy standby power supply can be prohibitively expensive. Furthermore, a power supply unit with the required specifications may be difficult to acquire at short notice and for the required duration. Particularly in the case of a remote or offshore wind turbine, these aspects add considerably to the operational costs of the wind turbine.

It is therefore an object of the invention to provide a means of powering wind turbine auxiliary devices that avoids the problems outlined above.

This object is achieved by the claimed auxiliary power supply arrangement, by the claimed wind turbine, and by the claimed method of operating a wind turbine.

### Description

In the following, it shall be understood that the auxiliary power supply of a wind turbine serves to supply power to auxiliary devices of the wind turbine in the absence of any other source of power such as the grid.

According to the invention, the auxiliary power supply arrangement comprises a standby power supply configured to supply the average power required by auxiliary devices of the wind turbine: and an energy storage unit which is configured to cover the peak power requirements of the auxiliary devices or which is configured to supplement the standby power supply in covering the peak power requirements of the auxiliary devices.

In the context of the invention, the “auxiliary devices of a wind turbine” include the permanent fixtures of the wind turbine itself as well as tools and equipment powered through electrical outlets of the wind turbine during stages of installation, commissioning, maintenance, etc. The expression “average power” as used herein shall be understood as the power consumed by the auxiliary devices during normal (“steady-state”) operation and during peak power consumption stages (when a device is switched on, for example). Peak power consumption of a device is generally only for a short duration, and has only a small influence on the average power. For this reason, the terms “average power” and “steady-state power” may be used interchangeably herein.

An advantage of the inventive auxiliary power supply arrangement is that the standby power supply of the auxiliary power supply arrangement can be considerably smaller than a prior art standby power supply which must—on its own—supply enough power to cover all peak power consumption situations. Because it has a relatively low capacity compared to the prior art standby power supply, the standby power supply of the inventive auxiliary power supply arrangement is lighter and less expensive. Furthermore, in cases where the standby power supply is not a permanent fixture or installation of the wind turbine, the relatively low-capacity standby power supply of the inventive auxiliary power supply arrangement is easier to rent or procure at short notice, and also more economical to transport to a remote or offshore location. Because the standby power supply of the inventive auxiliary power supply arrangement can be relatively small and light, it is easier to install at a wind turbine site.

Furthermore, since the capacity of the standby power supply of the inventive auxiliary power supply arrangement is significantly lower than the capacity of a prior art standby power supply, it need not be realised in the conventional manner, for example it need not be a diesel generator. Instead, the standby power supply of the inventive auxiliary power supply arrangement can comprise any of a gas turbine, a fuel cell, a battery with low power rating and high energy content, a photovoltaic module, a wave energy converter, a compressed-air energy storage module, etc.

According to the invention, the wind turbine comprises a number of permanently installed auxiliary devices (and possibly also a number of temporary auxiliary devices) requiring electrical power and an embodiment of the inventive auxiliary power supply arrangement to supply power to the auxiliary devices during off-grid operation of the wind turbine.

According to the invention, the method of operating a wind turbine comprises the steps of detecting an off-grid state: controlling the standby power supply of the auxiliary power supply arrangement to cover steady-state power consumption of the auxiliary devices: and discharging the energy storage unit to cover peak power consumption of the auxiliary devices. The standby power supply and the energy storage unit can be controlled so that the energy storage unit covers the peak power requirements of the auxiliary devices, or so that the energy storage unit supplements the standby power supply in covering the peak power requirements of the auxiliary devices.

Particularly advantageous embodiments and features of the invention are given by the dependent claims, as revealed in the following description. Features of different claim categories may be combined as appropriate to give further embodiments not described herein.

In the following, it may be assumed that a wind turbine is a horizontal-axis wind turbine with a number of rotor blades mounted to a hub, a nacelle mounted on a tower: and a generator arranged in the nacelle. The auxiliary devices of the wind turbine can be distributed according to their purpose, for example the yaw drive motors will be arranged about the top of the tower, pitch drive motors will be arranged about the rotor blade root ends, etc. In the following, without restricting the invention in any way, it may be assumed that the wind turbine is an offshore wind turbine.

The steady-state power consumption of the permanent and/or temporary auxiliary devices of a wind turbine during a grid off-state can be determined from empirical data, from a prediction of the power consumption under known operating conditions, etc. The steady-state power consumption may be affected by variables such a frequency of alteration of wind direction (requiring frequent yaw angle corrections), ambient temperature (cold conditions require more heating), humidity (damp conditions require more air-conditioning), wind speed (high wind speed may require feathering of the rotor blades), duration of use of a particular tool or piece of equipment, etc. Generally, the power consumption over time will be around this “steady-state” power level, with intermittent power peaks when a device such as a motor suddenly draws a large quantity of current.

Regardless of how the auxiliary devices of a wind turbine are provided with power, the amplitude of the power peaks or transients determine the total power consumed by the auxiliaries. The capacity of a prior art standby power supply must cover both average (steady-state) power consumption as well as peak (transient) power consumption, and may be considered as the reference capacity against which the capacities of the standby power supply and energy storage unit of the inventive auxiliary power supply arrangement are measured. In a particularly preferred embodiment, the capacity of the standby power supply of the inventive auxiliary power supply arrangement is at most 20% of the reference capacity. For example, with the inventive arrangement, a relatively economical and compact 30 kVA diesel genset could provide standby power to a configuration of auxiliary devices for a required duration (24 hours, 48 hours, etc.). If the same configuration of auxiliary devices were to be powered for the same duration by a single diesel genset as known from the prior art, a much larger and costlier 150 kVA diesel genset would be required.

In an exemplary embodiment of the invention, neither the energy storage unit nor the standby power supply are rated to cover the peak power requirements of the auxiliary devices. Instead, the energy storage unit is configured to supplement the standby power supply in covering the peak power requirements of the auxiliary devices. An advantage of this configuration is that neither power supply needs to be rated for the peak auxiliary load: the standby power supply need only be rated for the steady-state power consumption, and the energy storage unit need only cover the marginal power demand beyond the capability of the standby power supply.

In a preferred embodiment of the invention, the energy storage unit has an energy storage capacity in the order of 5 kWh-1 MWh, depending on how the standby power supply is realized. In a further preferred embodiment of the invention, the energy storage unit is configured to deliver power in the order of 50 kVA-400 kVA, depending on how the standby power supply is realized.

As indicated above, the standby power supply of the inventive auxiliary power supply arrangement can be a diesel generator that is smaller and more economical than a diesel generator that would otherwise be required to provide the reference power capacity. A standby power supply realised as a diesel generator will, of course, require refuelling at some point. However, the standby power supply of the inventive arrangement does not need to provide a consistent or constant level of power, but can provide fluctuating power levels so long as its average delivered power is no less than the steady state power consumption of the auxiliaries. The standby power supply therefore does not need to be a diesel genset, and alternative realisations are possible. In a preferred embodiment of the invention, the standby power supply can be a wave power device such as a point absorber buoy anchored near an offshore wind turbine. Equally, the standby power supply can be realised as any of a small gas turbine, a fuel cell, a compressed-air system, a large-capacity rechargeable battery, a photovoltaic arrangement, etc., and may even comprise any suitable combination of such power supply units. Depending on its energy source(s), the standby power supply may be essentially “inexhaustible”, i.e. it is continually replenished by an energy source. The standby power supply can comprise a large-capacity energy storage unit utilizing hydrogen produced by an electrolysis arrangement powered by compressed air, wind energy, a battery module, etc.

The energy storage capacity of the standby power supply is favourably large, and its power capacity can be favourably low, since it only needs to cover the steady-state consumption of the auxiliaries. The additional energy storage unit will ensure that any transient or peak power consumption is covered.

The energy storage unit of the inventive auxiliary power supply arrangement can be any device that can provide a large quantity of power over a short duration, since its purpose is to cover demand during peaks of the wind turbine auxiliary devices. In a particularly preferred embodiment of the invention, the energy storage unit comprises a battery arrangement such as a lithium-ion battery system, a supercapacitor system or a combination of such systems.

Together, the standby power supply and the energy storage unit ensure that the wind turbine auxiliary devices are provided with the power they require during an off-grid state. Of course, the energy storage unit is only needed when power demand exceeds the power being covered by the standby power unit. The energy storage unit is deployed only when the power required by the auxiliaries exceeds the power being delivered in that instant by the standby power supply. The only requirement of the standby power supply is that its “long-run average” is slightly higher than the steady-state average consumption of the auxiliaries. Whenever power consumption rises above this steady-state level, the energy storage unit can commence feeding power to the auxiliary devices, i.e. the energy storage unit can discharge power. This can be achieved by connecting the standby power supply and the energy storage unit in a suitable configuration.

In one embodiment, the energy storage unit is connected in series with the standby power supply, i.e. in an inline arrangement. In an alternative embodiment, the energy storage unit is connected in parallel with the standby power supply, i.e. in a line-interactive arrangement.

The elements of the auxiliary power supply arrangement preferably comprise suitable controllers and/or power electronics to respond to fluctuations in system voltage or frequency. The standby power supply and energy storage unit of the auxiliary power supply arrangement preferably collectively regulate their power output to maintain a stable system voltage or frequency. Fluctuating power consumption by the auxiliaries will result in fluctuations in system voltage or frequency, which are compensated by the collective performance of the standby power supply and energy storage unit. For example, should the standby power supply be unable to cover the requirements of the auxiliaries, the controllers and/or power electronics respond to initiate discharging of the energy storage unit to cover the deficit, thereby restoring the system voltage or frequency to its nominal level.

Similarly, if the momentary power consumption of the auxiliary devices is less than the power being provided by the standby power supply, the energy storage unit will recharge from the standby power supply so that, at some later point in time, it will be able to cover the demand of a power peak or transient. As long as recharging the energy storage unit does not decrease the system voltage or frequency, a controller or regulator of the energy storage unit will regulate the recharging procedure.

In a preferred embodiment of the invention, the wind turbine is provided with a monitoring unit (comprising any suitable controllers and/or power electronics) configured to monitor relevant quantities such as the power consumption of the auxiliaries, the capacity of the standby power supply, the capacity of the energy storage unit, etc. Such a monitoring unit may communicate with the wind turbine controller, which can issue commands as appropriate, for example to reduce power consumption of one or more of its auxiliary devices in order to ensure that the wind turbine can continue to remain operational until the grid is once again restored.

In a preferred embodiment of the invention, the inventive auxiliary power supply arrangement is configured to supply power to multiple wind turbines. For example, a suitably-scaled embodiment of the auxiliary power supply arrangement may be provided at a wind park substation to provide standby power to all auxiliaries in the event of a grid outage. Such an auxiliary power supply arrangement could provide power to the wind turbine auxiliaries via a network of inter-array cables through the wind park. The standby power supply may comprise any number of units that collectively cover the average power requirements of auxiliary devices of the wind turbines. An energy storage arrangement can comprise any number of energy storage units, which collectively cover transient power requirements of the auxiliary devices and/or supplement the standby power supply in covering the transient power requirements of the auxiliary devices.

Other objects and features of the present invention will become apparent from the following detailed descriptions considered in conjunction with the accompanying drawings. It is to be understood, however, that the drawings are designed solely for the purposes of illustration and not as a definition of the limits of the invention.

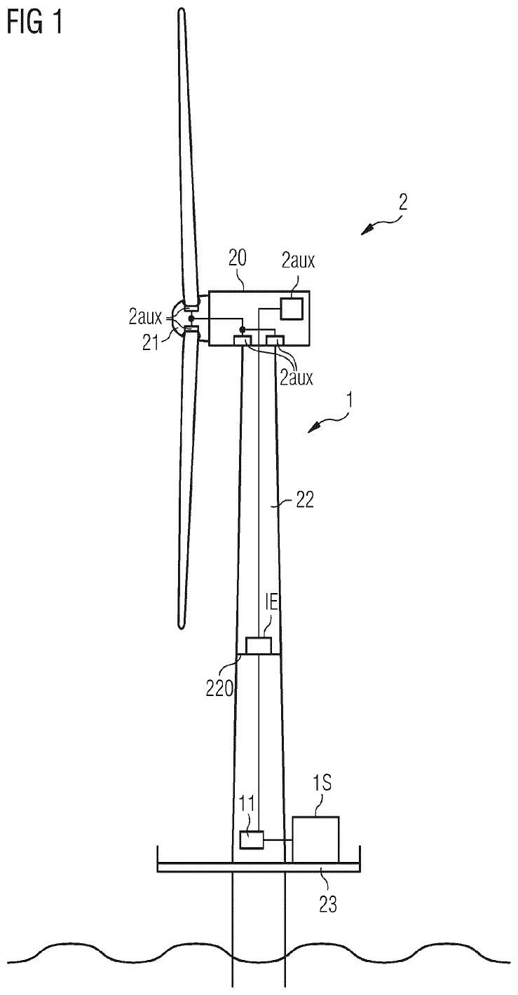

FIGS. 1-3 show an offshore wind turbine equipped with an auxiliary power supply arrangement according to the invention;

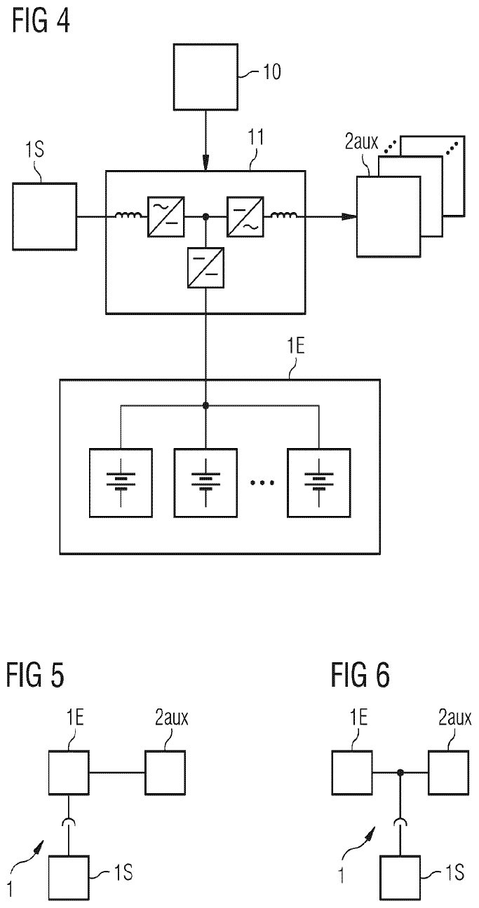

FIG. 4 shows an embodiment of the inventive auxiliary power supply arrangement;

FIGS. 5-6 show alternative configurations of the auxiliary power supply arrangement according to the invention;

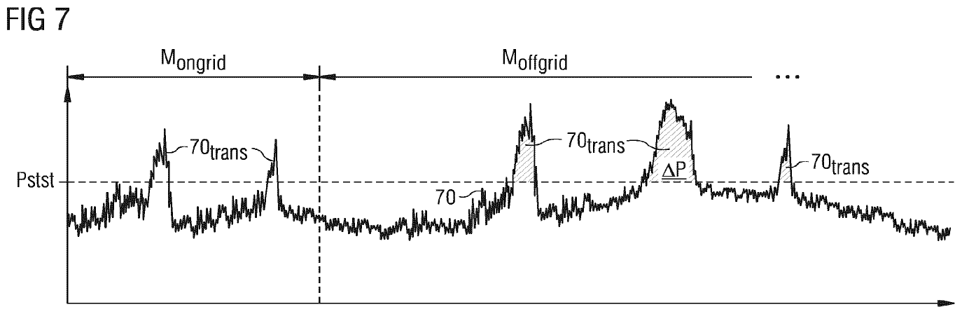

FIG. 7 shows power provided to the auxiliary devices of a wind turbine equipped with an embodiment of the inventive auxiliary power supply arrangement;

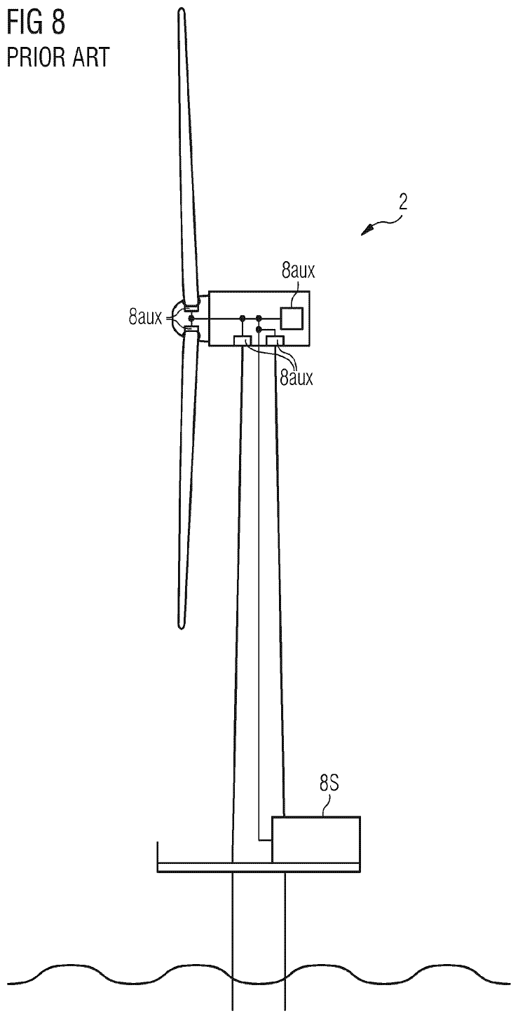

FIG. 8 shows a wind turbine equipped with a prior art standby power supply;

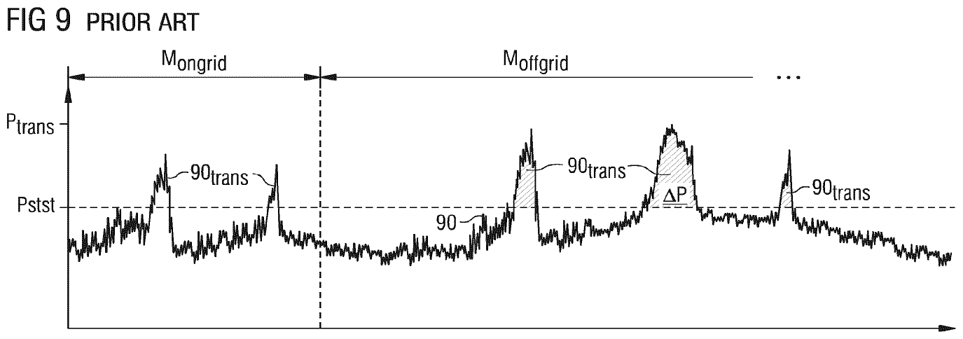

FIG. 9 shows power supply to the auxiliary devices of the wind turbine of FIG. 8;

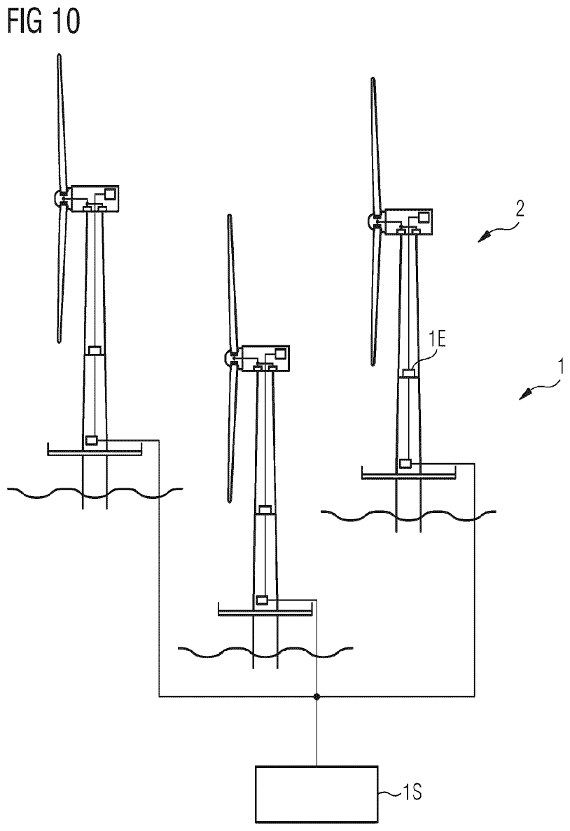

FIG. 10 shows a further embodiment of the invention

In the diagrams, like numbers refer to like objects throughout. Objects in the diagrams are not necessarily drawn to scale.

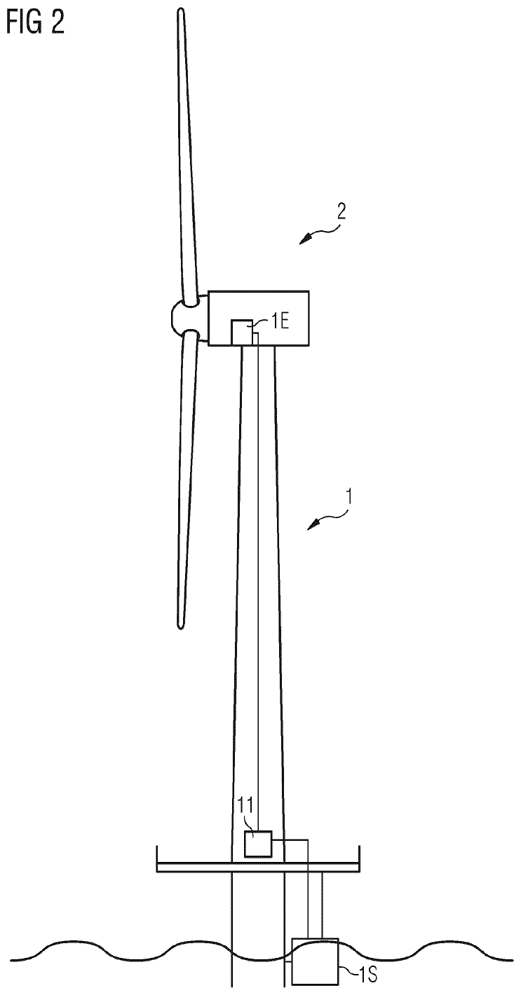

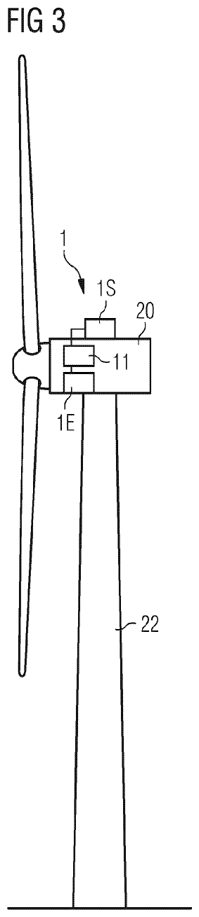

FIGS. 1-3 show an offshore wind turbine 2 equipped with an auxiliary power supply arrangement 1 according to the invention. In each case, the auxiliary power supply arrangement 1 comprises a standby power supply 1S configured to supply the average power required by auxiliary devices 2ₐᵤₓ of the wind turbine 2, and an energy storage unit 1E configured to supply peak power, or supplement the supply of peak power required by the auxiliary devices 1E. The auxiliary devices 2ₐᵤₓ can be permanently installed device such as yaw motors, pitch motors, climate control arrangement etc., or temporarily required tools and/or equipment, and can be distributed in various locations throughout the wind turbine 2, for example inside the nacelle 20, in the hub 21, in the tower, on a tower platform, etc. In FIG. 1, the standby power supply 1S is located on an external platform 23, and can be a diesel genset for example. The energy storage unit 1E is arranged on a platform 220 in the tower 22. The standby power supply 1S and the energy storage unit 1E are connected by a socket 11. In FIG. 2, the standby power supply 1S is a wave power device secured to a supporting structure of the wind turbine. Here, the energy storage unit 1E is arranged inside the nacelle 20, and the auxiliary power supply arrangement 1 provides power to the same arrangement of auxiliary devices 2ₐᵤₓ (not shown). In FIG. 3, the standby power supply 1S is arranged on top of the nacelle, and can be a photovoltaic module. The standby power supply 1S, as explained above, can comprise one or more modules that collectively provide standby power to the auxiliaries.

In any of the above configurations, the energy storage unit 1E can be a battery such as a lithium-ion battery, and can be located as indicated in the tower interior or inside the nacelle 20. The devices are connected by means of a socket 11 as shown in FIG. 4. The energy storage unit 1E is to contribute power to the auxiliary devices 2ₐᵤₓ when their peak power consumption exceeds the power produced by the standby power supply 1S. A monitoring unit 10 can keep a wind turbine controller (WTC) informed of the total capacity of the auxiliary power supply arrangement 1, so that the WTC can—if necessary—issue commands to reduce power consumption of one or more auxiliary devices 2ₐᵤₓ in order to ensure that the wind turbine 2 can remain operational until it is once again connected to the grid. The monitoring unit 10 can be part of the auxiliary power supply arrangement 1.

The standby power supply 1S and the energy storage unit 1E can be connected in series as shown in FIG. 5. Alternatively, the standby power supply 1S and the energy storage unit 1E can be connected in parallel as shown in FIG. 6.

During an on-grid mode M_{ongrid} operation of the wind turbine, power is supplied to the auxiliary devices 2ₐᵤₓ by the wind turbine itself or by the grid as shown in FIG. 7. The diagram indicates a fluctuating power demand 70. The demand of the auxiliary devices 2ₐᵤₓ is regularly below an average or steady-state level Pₛₜₛₜ. Occasionally, the auxiliary devices 2ₐᵤₓ draw a high current as indicated by the brief transients or peaks 70ₜᵣₐₙₛ, for example resulting from high inrush currents drawn by a yaw motor or pitch motor upon startup. During the on-grid mode M_{ongrid}, the power peaks 70ₜᵣₐₙₛ are easily covered by the essentially unlimited grid power.

However, in an off-grid mode M_{offgrid}, power to the auxiliary devices 2ₐᵤₓ must be supplied by the standby power supply 1S and the energy storage unit 1E. The power peaks 70ₜᵣₐₙₛ are no longer covered by a limitless power supply, but by the comparatively small standby power supply 1S and energy storage unit 1E of FIGS. 1-4. The average or steady-state power Pₛₜₛₜ is covered by the standby power supply 1S. When auxiliary devices draw a high current, the standby power supply 1S is not required to cover the power peak, and instead the deficit ΔP is made up by the energy storage unit 1E, which discharges power as required during the peak 70ₜᵣₐₙₛ until power consumption is once again at or below the power level Pₛₜₛₜ delivered by the standby power supply. Whenever power consumption is below that power level Pₛₜₛₜ, the energy storage unit 1E may be recharged from the standby power supply 1S, as necessary.

FIG. 8 shows a wind turbine 8 with a prior art standby power supply 8S. The specification of the standby power supply 8S is based on the peak power consumption that must be covered when an auxiliary device 8ₐᵤₓ draws a high “inrush” current for a brief period as explained above.

FIG. 9 illustrates the management of prior art auxiliary power for the wind turbine of FIG. 8. When the wind turbine 8 is operated in an off-grid mode M_{offgrid}, power to the auxiliary devices must be supplied by the standby power supply 8S. The diagram indicates a fluctuating power demand 90. Here also, while the demand of the auxiliary devices 8ₐᵤₓ is regularly below an average level Pₛₜₛₜ, an auxiliary device may occasionally draw a high current as indicated by the peaks 90ₜᵣₐₙₛ. Any such peak demand must be covered by the standby power supply 8S alone, so that the capacity of the standby power supply 8S must be accordingly large, for example in the order of 150 kVA-400 kVA.

FIG. 10 shows a further embodiment of the invention, in which the inventive auxiliary power supply arrangement 1 is configured to supply power to multiple wind turbines 2. A scaled-up standby power supply 1S may be provided at a wind park substation to provide standby power to all auxiliaries 2aux of all wind turbines 2 in the event of a grid outage. Such an auxiliary power supply arrangement 1 can provide standby power to the wind turbines 2 over a suitable network of power cables connecting the wind turbines of the wind park. Of course, the standby power supply 1S can comprise any number of units that collectively cover the average power requirements of the auxiliary devices of the wind turbines 2. The energy storage arrangement can comprise any number of energy storage units 1E, for example an energy storage unit 1E local to each wind turbine 2 as shown here, to cover transient power requirements of the auxiliary devices 2aux as explained above.

Although the invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1-15. (canceled)

16. An auxiliary power supply arrangement of a wind turbine, comprising:
a standby power supply configured to cover the average power requirements of auxiliary devices of the wind turbine; and
an energy storage unit, which energy storage unit is configured to cover transient power requirements of the auxiliary devices and/or to supplement the standby power supply in covering the transient power requirements of the auxiliary devices,
wherein the auxiliary devices are permanently installed devices and/or devices required temporarily during stages of installation, commissioning, or maintenance.

17. The auxiliary power supply arrangement according to claim 16, wherein the energy storage unit is a rechargeable energy storage module.

18. The auxiliary power supply arrangement according to claim 17, wherein the energy storage unit comprises any of: a lithium-ion battery, a supercapacitor arrangement.

19. The auxiliary power supply arrangement according to claim 16, wherein the energy storage unit has an energy storage capacity in the order of 5 kWh-1 MWh and a rated power output in the order of 50 kVA-400 kVA.

20. The auxiliary power supply arrangement according to claim 16, wherein the standby power supply generates power from a renewable energy source.

21. The auxiliary power supply arrangement according to claim 16, wherein the standby power supply comprises any of: a photovoltaic arrangement, a gas turbine, a fuel cell, a wave energy converter, a compressed-air energy storage module, a diesel generator.

22. The auxiliary power supply arrangement according to claim 16, wherein the energy storage unit and the standby power supply are connected in an inline arrangement.

23. The auxiliary power supply arrangement according to claim 16, wherein the energy storage unit and the standby power supply are connected in a line-interactive arrangement.

24. A wind turbine comprising:
an aerodynamic rotor mounted to a hub;
a nacelle mounted on a tower;
a generator arranged in the nacelle;
a number of auxiliary devices; and
an auxiliary power supply arrangement according to claim 16 configured to supply power to the auxiliary devices during an off-grid state of the wind turbine.

25. The wind turbine according to claim 24, wherein the capacity of the standby power supply of the auxiliary power supply arrangement is at most 20% of the capacity of a conventional art standby power supply required to provide power to the auxiliary devices.

26. The wind turbine according to claim 24, comprising a monitoring unit configured to monitor power consumed by the auxiliary devices.

27. The wind turbine according to claim 26, comprising a monitoring unit configured to control the operation of an auxiliary device on the basis of data provided by the monitoring unit.

28. A method of operating a wind turbine according to claim 24, comprising:
detecting an off-grid state;
controlling the standby power supply of the auxiliary power supply arrangement to cover the average power requirements of the auxiliary devices; and
discharging the energy storage unit to cover transient power requirements of the auxiliary devices.

29. The method according to claim 28, comprising recharging the energy storage unit from the standby power supply.

30. The method according to claim 28, wherein the energy storage unit is recharged when power consumption of the auxiliary devices is below the output power capacity of the standby power supply.
